(19) United States
(12) Patent Application Publication
(10) Pub. No.: US 2023/0235174 A1
(43) Pub. Date: Jul. 27, 2023

(54) CROSS-LINKABLE COMPOSITIONS BASED ON ORGANOSILICON COMPOUNDS

(71) Applicant: WACKER CHEMIE AG, Munich (DE)

(72) Inventors: Peter SCHÖLEY, Diera-Zehren (DE); Uwe SCHEIM, Coswig (DE)

(73) Assignee: Wacker Chemie AG, Munich (DE)

(21) Appl. No.: 18/023,748

(22) PCT Filed: Sep. 1, 2020
(86) PCT No.: PCT/EP2020/074337

§ 371 Date: Feb. 28, 2023

(51) Int. Cl. C08L 83/06; C08K 5/541

(52) U.S. Cl. CPC C08L 83/06; C08K 5/541; C08L 2312/08

(57) ABSTRACT

A composition crosslinkable by condensation reaction and producible using (A) organopolysiloxanes of the formula (R²O)₃₋ₐSiR¹ₐO(SiR₂O)ₙSiR¹ₐ(OR²)₃₋ₐ (I), (B1) silanes of the formula R³_{4-b}(R⁴O)_{b}Si (II), and optionally (B2) silicon compounds consisting of units of the formula R⁷_{c}(R⁸O)_{d}SiO_{(4-c-d)/2} (III). The composition contains organosilicon compounds having a molecular weight of less than or equal to 195 g/mol maximally in amounts of less than 0.5 wt%, based on organopolysiloxane (A).

The invention relates to compositions based on organosilicon compounds and crosslinkable by condensation reaction, to methods for producing them, and to their use as sealants, especially for the grouting of natural stones.

One-component sealants which are storable in the absence of water and which cure to elastomers on ingress of water at room temperature (RTV1 sealants) with elimination of alcohols are already known. These products are employed in large quantities in the construction industry, for example. The basis for these mixtures are organopolysiloxanes which carry alkoxy groups as hydrolyzable, reactive substituents. These reactive polydimethylsiloxanes are prepared in general by what is known as endcapping, this being the reaction of OH-terminal polydimethylsiloxanes with organyloxysilanes in the presence of catalysts. Reference may be made in this regard to US-A 5,055,502, for example. In order to suppress downstream reactions from the endcapping (chain extension and crosslinking), the organyloxysilanes always have to be used in a large excess, relative to the OH groups of the OH-terminated polydimethylsiloxanes. A consequence of this is that these organyloxy polymers always contain excess organyloxysilanes. It has also emerged that endcapping can be carried out in general only with very reactive organyloxysilanes such as methyltrimethoxysilane or vinyltrimethoxysilane, without equilibrations occurring.

Other reactive silanes also used are methyltriethoxysilane (MTEO) or vinyltriethoxysilane (VTEO). The reactivity of these two latter silanes, however, is already so low that there are limitations to their possible use in the endblocking of long-chain, OH-terminated polydimethylsiloxanes, as may be inferred from US-B2 10647822. These silanes, however, are indeed employed as additional additives, for example as water scavengers for increasing the storage stability, or else as carrier material for further active ingredients such as stabilizers or catalysts, for example.

The profile of requirements imposed on RTV1 sealants is broad, but there is a desire in particular for products which cure extremely rapidly after a certain processing time. In addition to the catalysts used in the RTV1 sealant, a decisive factor here is in particular the reactivity of the crosslinkers used. In particular, the compounds of tin and of titanium that are typically employed have the disadvantage of leading to storage stability problems or to instances of unwanted yellowing. A concern is therefore to limit the amounts of catalysts used in the RTV1 sealant. In that case, however, the pressure to use very reactive silanes is even greater.

Furthermore, these sealants may comprise fillers, plasticizers, crosslinkers, and various additives.

Additionally it is customary to use functionalized alkylsilanes as what are called adhesion promoters. A typical example thereof is the use of aminopropyltrimethoxysilane.

Of course, all of these alkoxysilanes additionally present in the RTV1 sealants as well as methyltrimethoxysilane may also influence the curing properties such as skin formation time, early strength, and through-curing. This influence, however, is very small and can generally be disregarded. When these silanes are used in the RTV1 sealants described, however, there are disadvantages affecting production, storage, and use.

One critical disadvantage of existing RTV1 sealants is that, in grouting scenarios, substrates bordering the RTV1 sealant, especially natural stone, may become soiled. This is caused principally by plasticizers not incorporated into the polymer matrix. They are able to migrate from the sealant and form a dark-colored margin with a greasy appearance at the area of contact with the substrate.

A known solution to this problem is to use very short-chain plasticizers, as disclosed in DE-B 102 27 590. It has nevertheless emerged that there is a further type of soiling, which is manifested only when the substrate becomes wet. Regions bordering the sealant are so strongly hydrophobic that they are not wetted by the water and in that case appear a much lighter color than the rest of the substrate. This phenomenon occurs irrespective of the particular plasticizer employed. It also occurs if no plasticizers at all are added.

In contrast to the very reactive organyloxysilanes described above, organyloxysilanes having high molecular weights are characterized by low reactivities, as they contain long-chain organyloxy radicals as well as long-chain organyl radicals bonded directly to silicon.

A subject of the invention are compositions crosslinkable by condensation reaction and producible using
(A) organopolysiloxanes of the formula

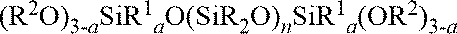

where
   R may be identical or different and denotes monovalent, optionally substituted hydrocarbon radicals,
   R¹ may be identical or different and denotes monovalent, optionally substituted hydrocarbon radicals,
   R² may be identical or different and denotes monovalent, optionally substituted hydrocarbon radicals,
   a may be identical or different and is 0 or 1, preferably 1, and
   n is an integer from 380 to 2000,
   with the proviso that the viscosity at 25° C. is greater than or equal to 6000 mPas,
(B1) silanes of the formula

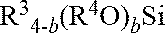

in which
   R³ may be identical or different and denotes a monovalent, SiC-bonded, optionally substituted hydrocarbon radical,
   R⁴ may be identical or different and denotes a monovalent, optionally substituted hydrocarbon radical, and
   b is 2, 3 or 4, preferably 2 or 3,
   with the proviso that the molecular weight of the silanes of the formula (II) is greater than 195 g/mol, and optionally
(B2) silicon compounds consisting of the units of the formula

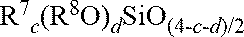

in which
   R⁷ may be identical or different and denotes a monovalent, SiC-bonded, optionally substituted hydrocarbon radical,
   R⁸ may be identical or different and denotes a monovalent, optionally substituted hydrocarbon radical,
   c is 0, 1 or 2, and
   d is 0, 1, 2 or 3,
   with the proviso that in formula (III) the sum c+d is ≤3, there are at least 2 groups (R⁸O) present in the silicon compounds, and the viscosity at 25° C. is less than 2000 mPas,
   with the proviso that the compositions of the invention comprise organosilicon compounds having a molecular weight of less than or equal to 195 g/mol maximally in amounts of less than 0.5 wt%, preferably in amounts of less than 0.1 wt%, based in each case on organopolysiloxane (A).

Examples of radicals R are alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical; hexyl radicals, such as the n-hexyl radical; heptyl radicals, such as the n-heptyl radical; octyl radicals, such as the n-octyl radical and isooctyl radicals, such as the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical; cycloalkyl radicals, such as the cyclopentyl, cyclohexyl, cycloheptyl radical and methylcyclohexyl radicals; alkenyl radicals, such as the vinyl, 1-propenyl and the 2-propenyl radical; aryl radicals, such as the phenyl, naphthyl, anthryl and phenanthryl radical; alkaryl radicals, such as o-, m-, p-tolyl radicals; xylyl radicals and ethylphenyl radicals; and aralkyl radicals, such as the benzyl radical, the α- and the β-phenylethyl radical.

The radicals R are preferably monovalent hydrocarbon radicals having 1 to 18 carbon atoms, more preferably methyl, vinyl or phenyl radical, more particularly the methyl radical.

Examples of radicals R¹ are the monovalent hydrocarbon radicals indicated for R, and also hydrocarbon radicals substituted by amino groups.

Radical R¹ preferably comprises monovalent hydrocarbon radicals that have 1 to 12 carbon atoms and are optionally substituted by amino groups, and more preferably comprises methyl radical, ethyl radical, vinyl radical, phenyl radical, radical —CH₂—NR^{6′}R^{5′} or the radical CH₂NR^{11′}, where R^{5′} denotes hydrocarbon radicals having 1 to 12 carbon atoms, R⁶^{′} denotes hydrogen atom or radical R^{5′}, and R^{11′} denotes divalent hydrocarbon radicals which may be interrupted by heteroatoms.

More particularly radical R¹ comprises radical —CH₂—NR^{6‘}R^{5‘} or radical CH₂NR^{11′}, where R^{5′}, R^{6′} and R^{11′} have the same meaning as that stated above, and very preferably comprises —CH₂—N[(CH₂)₂]₂O, —CH₂—N(Bu)₂ or -CH₂-NH(cHex), where Bu denotes n-butyl radical and cHex denotes cyclohexyl radical.

Examples of radicals R⁵ and R^{5′} are, independently of one another, the hydrocarbon radicals indicated for R.

Preferably radical R⁵ and R^{5′} independently of one another comprise the methyl, ethyl, isopropyl, n-propyl, n-butyl, cyclohexyl or phenyl radical, more preferably the n-butyl radical.

Examples of hydrocarbon radicals R⁶ and R^{6′} are, independently of one another, the hydrocarbon radicals indicated for R.

Preferably radical R⁶ and R^{6′} independently of one another comprise hydrogen atom, the methyl, ethyl, isopropyl, n-propyl, n-butyl or cyclohexyl radical, more preferably the n-butyl radical.

Examples of divalent radicals R¹¹ and R^{11′} are, independently of one another, alkylene radicals, such as the propane-1,3-diyl, butane-1,4-diyl, butane-1,3-diyl, 2-methylpropane-1,3-diyl, pentane-1,5-diyl, pentane-1,4-diyl, 2-methylbutane-1,4-diyl, 2,2-dimethylpropane-1,3-diyl, hexane-1,6-diyl, heptane-1,7-diyl, octane-1,8-diyl and 2-methylheptane-1,7-diyl and 2,2,4-trimethylpentane-1,5-diyl radical; alkenylene radicals, such as the propene-1,3-diyl radical; and also radicals —CH₂—CH₂—O—CH₂—CH₂— and —CH₂—CH₂—NH—CH₂—CH₂—.

Radical R¹¹ and R^{11′} independently of one another preferably comprise divalent hydrocarbon radicals having 4 to 6 carbon atoms which may be interrupted by heteroatoms, preferably oxygen —O— or nitrogen —NH—, and more preferably comprise CH₂—CH₂—O—CH₂—CH₂—.

Examples of radicals R² are the monovalent radicals indicated for R.

The radicals R² preferably comprise alkyl radicals having 1 to 12 carbon atoms, more preferably methyl, ethyl, n-propyl or isopropyl radicals, and more particularly the methyl or the ethyl radical.

The organopolysiloxanes (A) used in the invention preferably comprise
(MeO)₂Si(Ox)O(SiMe₂O)₃₀₋₂₀₀₀Si(Ox)(OMe)₂,
(MeO)₂Si(DBA)O(SiMe₂O)₃₀₋₂₀₀₀Si(DBA)(OMe)₂,
(MeO)₂Si(cHx)O(SiMe₂O)₃₀₋₂₀₀₀Si(cHx)(OMe)₂,
(MeO)₂Si(R³)O(SiMe₂O)₇₀₀Si(R³)(OMe)₂,
(EtO)₂Si(Ox)O(SiMe₂O)₃₀₋₂₀₀₀Si(Ox)(OEt)₂,
(EtO)₂Si(DBA)O(SiMe₂O)₃₀₋₂₀₀₀Si(DBA)(OEt)₂,
(EtO)₂Si(cHx)O(SiMe₂O)₃₀₋₂₀₀₀Si(cHx)(OEt)₂ or
(EtO)₂Si(R¹)O(SiMe₂0)₇₀₀Si(R¹)(OEt)₂, more preferably
(EtO)₂Si(Ox)O(SiMe₂O)₃₀₋₂₀₀₀Si(Ox)(OEt)₂,
(EtO)₂Si(DBA)O(SiMe₂O)₃₀–₂₀₀₀Si(DBA)(OEt)₂ or
(EtO)₂Si(cHx)O(SiMe₂O)₃₀–₂₀₀₀Si(cHx)(OEt)₂, more particularly
(EtO)₂Si(Ox)O(SiMe₂O)₃₀–₂₀₀₀Si(Ox)(OEt)₂, in which Me is methyl radical, Et is ethyl radical, Ox is CH₂—N[(CH₂)₂]₂O, DBA is —CH₂—N(nBu)₂, cHx is CH₂-NH(cHex), Bu is n-butyl radical and cHex is cyclohexyl radical, and also R¹ denotes Me, Et, vinyl radical, phenyl radical, DBA, Ox or cHx and has an identical meaning within the individual compounds.

The organopolysiloxanes (A) used in the invention have a viscosity of preferably 6000 to 350 000 mPas, more preferably of 20 000 to 120 000 mPas, in each case at 25° C.

The organopolysiloxanes (A) are commercially customary products and/or may be prepared by methods commonplace in silicon chemistry.

Examples of radicals R³ are the radicals indicated for R.

The radicals R³ are preferably linear, branched or cyclic hydrocarbon radicals having 1 to 16 carbon atoms, or monovalent hydrocarbon radicals that have 1 to 12 carbon atoms and are substituted by amino groups on the carbon atom bonded to the silicon atom, and more preferably are linear, branched or cyclic alkyl radicals having 1 to 8 carbon atoms, vinyl radical, phenyl radical, radical —CH₂—NR^{6′}R^{5′} or the radical CH₂NR^{11′}, where R^{5′} denotes hydrocarbon radicals having 1 to 12 carbon atoms, R^{6′} denotes hydrogen atom or radical R^{5′}, and R^{11′} denotes divalent hydrocarbon radicals which may be interrupted by heteroatoms.

Examples of radicals R⁴ are the radicals indicated for R.

Preferably the radicals R⁴ are methyl, ethyl, n-propyl, isopropyl, n-butyl, s-butyl or isobutyl radical, more preferably ethyl, n-propyl or isopropyl radical.

Examples of component (B1) used optionally in the invention are n-hexyltrimethoxysilane, n-heptyltrimethoxysilane, n-octyltrimethoxysilane, n-nonyltrimethoxysilane, n-decyltrimethoxysilane, n-hexadecyltrimethoxysilane, cyclohexyltrimethoxysilane, phenyltrimethoxysilane, n-propyltriethoxysilane, n-butyltriethoxysilane, n-pentyltriethoxysilane, n-hexyltriethoxysilane, n-heptyltriethoxysilane, n-octyltriethoxysilane, n-nonyltriethoxysilane, n-decyltriethoxysilane, n-hexadecyltriethoxysilane, cyclohexyltriethoxysilane, phenyltriethoxysilane, methyltri-n-propoxysilane, etyltri-n-propoxysilane, n-propyltri-n-propoxysilane, n-butyltri-n-propoxysilane, n-pentyltri-n-propoxysilane, n-hexyltri-n-propoxysilane, n-heptyltri-n-propoxysilane, n-octyltri-n-propoxysilane, n-nonyltri-n-propoxysilane, n-decyltri-n-propoxysilane, n-hexadecyltri-n-propoxysilane, cyclohexyltri-n-propoxysilane, phenyltri-n-propoxysilane, methyltriisopropoxysilane, etyltriisopropoxysilane, n-propyltriisopropoxysilane, n-butyltriisopropoxysilane, n-pentyltriisopropoxysilane, n-hexyltriisopropoxysilane, n-heptyltriisopropoxysilane, n-octyltriisopropoxysilane, n-nonyltriisopropoxysilane, n-decyltriisopropoxysilane, n-hexadecyltriisopropoxysilane, cyclohexyltriisopropoxysilane, phenyltriisopropoxysilane, 2,2,4-trimethylpentyltrimethoxysilane, tetraethoxysilane, tetra-n-propoxysilane, tetraisopropoxysilane, 2,2,4-trimethylpentyltriethoxysilane, (2,3,5,6-tetrahydro-1,4-oxazin-4-yl)methyltriethoxysilane, N,N-di-n-butylaminomethyltriethoxysilane, N-cyclohexylamionomethyltriethoxysilane, (2,3,5,6-tetrahydro-1,4-oxazin-4-yl)methyltrimethoxysilane N,N—Di—n-butylaminomethyltrimethoxysilane and N-cyclohexylmethyltrimethoxysilane.

Preferably the silanes (B1) used in the invention are tetraethoxysilane, 2,2,4-trimethylpentyltrimethoxysilane, (2,2,5,6-tetrahydro-1,4-oxazin-4-yl)methyltriethoxysilane, phenyltrimethoxysilane or n-hexadecyltrimethoxysilane.

Component (B1) comprises commercially customary products or may be produced by methods commonplace in silicon chemistry.

The compositions of the invention comprise component (B1) in amounts of preferably 0.5 to 7 parts by weight, more preferably of 1 to 3.5 parts by weight, based in each case on 100 parts by weight of component (A).

Examples of radicals R⁷ are the radicals indicated for R.

The radicals R⁷ are preferably the methyl radical or the 2,2,4-trimethylpentyl radical.

Examples of radicals R⁸ are the radicals indicated for R.

The radicals R⁸ are preferably the methyl radical or ethyl radical, more preferably the methyl radical.

Preferred examples of silcon compounds (B2) used optionally in the invention are
EtO(SiMe₂O)₃SiR⁷(OEt)₂,
(EtO(SiMe₂O)₃)₂SiR⁷(OEt),
MeO(SiMe₂O)₃SiR⁷(OMe)₂,
(MeO(SiMe₂O)₃)₂SiR⁷OMe),
EtO(SiMe₂O)₃SiR⁷(OEt)O(SiMe₂O)₃SiR⁷ (OEt)₂,
MeO(SiMe₂O)₃SiR⁷(OMe)O(SiMe₂O)₃SiR⁷ (OMe)₂
EtO(SiMe₂O)ₓSi(iOct)(OEt)₂,
(EtO(SiMe₂O)ₓ)₂Si(iOct)(OEt),
MeO(SiMe₂O)ₓSi(iOct)(OMe)₂,
(MeO(SiMe₂O)ₓ)₂Si(iOct)(OMe),
EtO(SiMe₂O)ₓSi(iOct)(OEt)O(SiMe₂O)₃Si(iOct)(OEt)₂,
MeO(SiMe₂O)ₓSi(iOct)(OMe)O(SiMe₂O)₃Si(iOct)(OMe)₂,
[(EtO)₃SiO_{½}][(EtO)₂SiO_{2/2}][(EtO)SiO_{3/2}][SiO_{4/2}] or
[(EtO)₂SiMeO_{½}][(EtO)SiMeO_{2/2}][MeSiO_{3/2}],
where Me is methyl radical, Et is ethyl radical, iOct is 2,2,4-trimethylpentyl radical, x=1-9, and R⁷ denotes straight-chain, branched or cyclic, aliphatic hydrocarbon radicals having 2 to 8 hydrocarbon atoms, with the radicals R⁷ having an identical definition within the individual compounds.

The silicon compounds (B2) used optionally in the invention are more preferably MeO(SiMe₂O)ₓSi(iOct)(OMe)₂, (MeO(SiMe₂O)ₓ)₂Si(iOct)(OMe), MeO(SiMe₂O)ₓSi(iOct)(OMe)O(SiMe₂O)₃Si(iOct)(OMe)₂, [(EtO)₃SiO_{½}]_{0.37}[(EtO)₂SiO_{2/2}]_{0.41}[(EtO)SiO_{3/2}]_{0.20}[SiO_{4/2}]_{0.02} or [(EtO)₂SiMeO_{½}]_{0.18}[(EtO)SiMeO_{2/2}]_{0.48}[MeSiO_{3/2}]_{0.34} where Me is methyl radical, Et is ethyl radical, iOct is 2,2,4-trimethylpentyl radical, and x = 1-9.

The silicon compounds (B2) used optionally in the invention have a viscosity of preferably 5 to 15 mPas at 25° C.

The silicon compounds (B2) used optionally in the invention preferably have a molecular weight of greater than 195 g/mol.

More particularly the silicon compounds (B2) used optionally have the average composition [R⁷(OMe)₂O_{½}]ₑ[R⁷Si(OMe)O_{2/2}]_{f}[R⁷SiO_{3/2}]_{g}[Me₂SiO_{2/2}]ₕ[Me₂Si(OMe)O_{½}]ᵢ, where e= 0.05-0.15, f= 0.10-0.20, g= 0.00-0.10, h= 0.40-0.65 and i= 0.10-0.30, with e+f+g < h+i and e+f+g+h+i=1, with Me being methyl radical and R⁷ having the definition stated above.

The silicon compounds (B2) used optionally may be prepared by methods commonplace in silicon chemistry, such as, for example, by equilibration of polydimethylsiloxanes with trialkoxysilanes under basic catalysis.

If the compositions of the invention include component (B2), the amounts in question are preferably 1 to 20 parts by weight, more preferably 1 to 10 parts by weight, more particularly 2 to 6 parts by weight, based in each case on 100 parts by weight of component (A).

Additionally to components (A), (B1) and optionally (B2), the compositions of the invention may comprise all substances which have also been employed to date in compositions crosslinkable by condensation reaction, such as, for example, adhesion promoters (C), curing accelerators (D), plasticizers (E), fillers (F) and additives (G).

Adhesion promoters (C) used may be all adhesion promoters which have also been used to date in compositions crosslinkable by condensation reaction.

Preferably adhesion promoter (C) comprises organyloxysilanes having glycidyloxy, amino, ureido, acryloyloxy or methacryloyloxy groups, and also partial condensates thereof.

Examples of adhesion promoters (C) are 3-aminopropyltrimethoxysilane, 3-aminopropyltriethoxysilane, 3-(2-aminoethyl)aminopropyltrimethoxysilane, 3-(2-aminoethyl)aminopropyltriethoxysilane, 3-glycidyloxypropyltrimethoxysilane, 3-glycidyloxypropyltriethoxysilane, 3-methacryloyloxypropyltrimethoxysilane, 3-methacryloyloxypropyltriethoxysilane, 3-ureidopropyltrimethoxysilane, 3-ureidopropyltriethoxysilane, 3-aminopropyldimethoxymethylsilane, 3-aminopropyldiethoxymethylsilane, 3-(2-aminoethyl)aminopropyldimethoxymethylsilane and 3-(2-aminoethyl)aminopropyldiethoxymethylsilane.

If the compositions of the invention include adhesion promoters (C), the amounts involved are preferably 0.5 to 5.0 parts by weight, more preferably 1 to 3 parts by weight, based in each case on 100 parts by weight of constituent (A).

Curing accelerators (D) used may be all curing accelerators which have also been used to date in compositions crosslinkable by condensation reaction.

Examples of curing accelerators (D) are titanium compounds, such as, for example, tetrabutyl or tetraisopropyl titanate, or titanium chelates, such as bis(ethylacetoacetato)diisobutoxytitanium, or organotin compounds, such as di-n-butyltin dilaurate and di-n-butyltin diacetate, di-n-butyltin oxide, dimethyltin diacetate, dimethyltin dilaurate, dimethyltin dineodecanoates, dimethyltin oxide, di-n-octyltin diacetate, di-n-octyltin dilaurate, di-n-octyltin oxide, and also products of reaction of these compounds with alkoxysilanes, such as the reaction product of di-n-butyltin diacetate with tetraethoxysilane, with preference being given to di-n-octyltin diacetate, di-n-octyltin dilaurate, dioctyltin oxide, reaction products of di-n-octyltin oxide with tetraethoxysilane, tetrabutyl titanate, tetraisopropyl titanate or bis(ethylacetoacetato)diisobutoxytitanium.

If the compositions of the invention include curing accelerators (D), the amounts involved are preferably 0.001 to 20 parts by weight, more preferably 0.001 to 1 part by weight, based in each case on 100 parts by weight of constituent (A).

Examples of plasticizers (E) used optionally are dimethylpolysiloxanes which are liquid at room temperature and are end blocked by trimethylsiloxy groups, having viscosities at 25° C. more particularly in the range between 5 and 1000 mPas, and also high-boiling hydrocarbons, such as, for example, liquid paraffins or mineral oils consisting of naphthenic and paraffinic units.

If the compositions of the invention include component (E), the amounts involved are preferably 5 to 30 parts by weight, more preferably 5 to 25 parts by weight, based in each case on 100 parts by weight of siloxanes (A). The compositions of the invention preferably do not contain any plasticizer (E).

The fillers (F) used optionally in the compounds of the invention may be any desired fillers known to date.

Examples of optionally employed fillers (F) are nonreinforcing fillers (F), these being fillers having a BET surface area of up to 20 m²/g, such as quartz, diatomaceous earth, calcium silicate, zirconium silicate, zeolites, metal oxide powders, such as aluminum oxides, titanium oxides, iron oxides or zinc oxides and/or mixed oxides thereof, barium sulfate, calcium carbonate, gypsum, silicon nitride, silicon carbide, boron nitride, glass powder and plastics powders, such as polyacrylonitrile powder; reinforcing fillers, these being fillers having a BET surface area of more than 20 m²/g, such as precipitated chalk and carbon black, such as furnace black and acetylene black; silica, such as pyrogenically produced silica and precipitated silica; and fibrous fillers, such as plastics fibers.

The optionally employed fillers (F) are preferably calcium carbonate or silica, more preferably silica or a mixture of silica and calcium carbonate.

Preferred calcium carbonate products (F) are ground or precipitated and optionally surface-treated with fatty acids such as stearic acid or salts thereof. The preferred silica is preferably pyrogenic silica.

If the compositions of the invention include fillers (F), the amounts involved are preferably 10 to 150 parts by weight, more preferably 10 to 130 parts by weight, more particularly 10 to 100 parts by weight, based in each case on 100 parts by weight of organopolysiloxanes (A). The compositions of the invention preferably comprise filler (F).

Examples of additives (G) are pigments, dyes, odorants, oxidation inhibitors, agents for influencing the electrical properties, such as conductive carbon black, flame retardants, light stabilizers, biocides such as fungicides, bactericides and acaricides, cell-generating agents, e.g. azodicarbonamide, heat stabilizers, scavengers, such as Si-N containing silazanes or silylamides, e.g., N,N′-bistrimethylsilylurea or hexamethyldisilazane, cocatalysts, such as Lewis and Brönstedst acids, e.g., sulfonic acids, phosphoric acids, phoshoric esters, phosphonic acids and phosphonic esters, thixotropic agents, such as, for example, hydrogenated castor oil or polyethylene glycol end-terminated with OH on one or both sides, agents for further regulation of the modulus, such as polydimethylsiloxanes having an OH end group, and any desired siloxanes different from components (A), (B) and (C).

If the compositions of the invention include additives (G), the amounts involved are preferably 0.1 to 20 parts by weight, more preferably 0.1 to 15 parts by weight, more particularly 0.1 to 10 parts by weight, based in each case on 100 parts by weight of organopolysiloxanes (A). The compositions of the invention preferably comprise component (G).

The individual constituents of the compositions of the invention may in each case be one kind of such a constituent or else a mixture of at least two different kinds of such constituents.

The compositions of the invention are preferably produced using no constituents beyond components (A) to (G).

The compositions of the invention are preferably compositions producible using
(A) organopolysiloxanes of the formula (I),
(B1) silanes of the formula (II),
(B2) silicon compounds consisting of units of the formula (III),
optionally (C) adhesion promoters,
optionally (D) curing accelerators,
optionally (E) plasticizers,
optionally (F) fillers, and
optionally (G) additives.

The compositions of the invention are more preferably compositions producible using
(A) organopolysiloxanes of the formula (I),
(B1) silanes of the formula (II),
(B2) silicon compounds consisting of units of the formula (III),
(C) adhesion promoters,
optionally (D) curing accelerators,
optionally (E) plasticizers,
optionally (F) fillers, and
optionally (G) additives.

The compositions of the invention are more particularly compositions producible using
(A) organopolysiloxanes of the formula (I),
(B1) silanes of the formula (II),
(B2) silicon compounds consisting of units of the formula (III),
(C) adhesion promoters,
(D) curing accelerators,
optionally (E) plasticizers,
(F) fillers, and
optionally (G) additives.

In another preferred embodiment the compositions of the invention are compositions producible using
(A) organopolysiloxanes of the formula (I),
(B1) silanes of the formula (II),
(B2) silicon compounds consisting of units of the formula (III),
(C) adhesion promoters,
(D) curing accelerators,
(F) fillers, and
optionally (G) additives,
with the proviso that they are free from (E) plasticizers.

In a further preferred embodiment the compositions of the invention are compositions producible using
(A) organopolysiloxanes of the formula (I),
(B1) silanes of the formula (II),
(B2) siloxanes consisting of units of the formula (III),
(C) adhesion promoters,
(D) curing accelerators,
(F) fillers, and
(G) additives,
with the proviso that they are free from (E) plasticizers.

For preparing the compositions of the invention, all of the constituents can be mixed with one another in any order. This mixing may take place at room temperature and under the pressure of the surrounding atmosphere, in other words about 900 to 1100 hPa. If desired, however, this mixing may also take place at higher temperatures, such as at temperatures in the range from 35 to 135° C., for example. Additionally it is possible to carry out mixing temporarily or continually under reduced pressure, such as at an absolute pressure of 30 to 500 hPa, for example, in order to remove volatile compounds or air.

The mixing of the invention takes place preferably very largely in the absence of water, i.e., using raw materials which have a water content of preferably less than 10 000 mg/kg, more preferably of less than 5000 mg/kg, more particularly of less than 1000 mg/kg. The mixing operation is preferably carried out with blanketing using dry air or inert gas such as nitrogen, with the gas in question having a moisture content of preferably less than 10 000 µg/kg, more preferably of less than 1000 µg/kg, more particularly of less than 500 µg/kg. Following their production, the compositions are preferably dispensed into commercially customary moisture-proof containers, such as cartridges, tubular pouches, pails and drums, for example.

In one preferred procedure first components (A), (B), optionally (C) and (E) are mixed with one another, after which any fillers (F) are added, and lastly, any further constituents (D) and (G) are added, with the temperature during mixing preferably not exceeding 60° C.

A further subject of the invention is a method for producing the composition of the invention by mixing of the individual constituents.

The method of the invention may take place continuously, batchwise or semi-batchwise according to known processes and using known apparatuses.

The compositions of the invention and/or compositions produced in accordance with the invention are storable in the absence of moisture and crosslinkable on ingress of moisture.

The typical water content of the air is sufficient for crosslinking the compositions of the invention. The compositions of the invention are crosslinked preferably at room temperature. If desired they may also be crosslinked at temperatures higher or lower than room temperature, e.g., at -5° to 15° C. or at 30° C. to 50° C., and/or by means of water concentrations which exceed the normal water content of the air.

The crosslinking is carried out preferably at a pressure of 100 to 1100 hPa, more particularly at the pressure of the surrounding atmosphere, in other words about 900 to 1100 hPa.

A further subject of the present invention are shaped articles produced by crosslinking the composition of the invention.

The shaped articles of the invention have a stress at 100% elongation of preferably less than 0.4 MPa, measured on ISO 37 type 2 test specimens.

The compositions of the invention may be employed for all purposes for which it is possible to employ compositions which are storable in the absence of water and which crosslink to elastomers on ingress of water at room temperature.

Surprisingly it has been found that with exclusive use of silanes having molecular weights of more than 195 g/mol, it is possible to produce sealants having good reactivity and high storage stability.

It has additionally been possible to show, surprisingly, that crosslinkable compositions based exclusively on silanes with high molecular weights do not lead to marginal-zone soiling affecting natural stone grouting even when at the same time they do not contain any inert plasticizers. There was no expectation that such unwanted effects could be avoided entirely by means of a relatively small increase in the molecular weights. The expectation of the skilled person, on the contrary, would have been that alkoxysilanes having high molecular weights, owing to the lower reactivity, would need more time in order to be able to diffuse out of the RTV1 sealant in the course of the curing of the sealant. The effect of the marginal-zone soiling as a result of hydrophobization of the natural stone surface would therefore have tended to be reinforced, not least because longer alkyl radicals further boost the hydrophobization effect.

The compositions of the invention therefore have excellent suitability as, for example, sealing compounds for joints, including vertical joints, and similar cavities with a clear width, for example, of 10 to 40 mm, in – for example – buildings, land vehicles, watercraft and aircraft, or as adhesives or cementing compounds, in window construction or in the production of display cases, for example, and also, for example, in the production of protective coatings, including those for surfaces exposed to the continual action of fresh or salt water or slip-preventing coatings, or elastomeric moldings.

An advantage of the compositions of the invention is that they are easy to produce and are distinguished by very high storage stability.

A further advantage of the compositions of the invention is that they display very good handling qualities in use and have excellent processing properties in a multiplicity of application.

An advantage of the crosslinkable compositions of the invention is that the modulus can be custom-tailored.

An advantage of the crosslinkable compositions of the invention is that they adhere very well to a multiplicity of substrates.

An advantage of the crosslinkable compositions of the invention is that they do not cause any marginal-zone soiling of the adjacent substrates. In particular they have outstanding suitability to allow natural and artificial stones to be grouted without contamination of the marginal zones.

An advantage of the crosslinkable compositions of the invention is that they are very economical in terms of the substances used.

In the examples described below, all viscosity data relate to a temperature of 25° C. Unless otherwise indicated, the examples below are carried out at a pressure of the surrounding atmosphere, in other words approximately at 1000 hPa, and at room temperature, in other words at about 23° C., or at a temperature which comes about when the reactants are combined at room temperature without additional heating or cooling, and also at a relative atmospheric humidity of about 50%. Furthermore, all parts and percentages data, unless otherwise indicated, relate to the weight.

The tensile strength, elongation at break, and the stress at 100% elongation are determined according to ISO 37 on type 2 test specimens.

In the context of the present invention, the dynamic viscosity of the organosilicon compounds is measured according to DIN 53019. The procedure for this was as follows: the viscosity, unless otherwise indicated, is measured at 25° C. by means of a Physica MCR 300 rotational rheometer from Anton Paar. For viscosities of 1 to 200 mPa·s, a coaxial cylinder measuring system (CC 27) with an annular measuring gap of 1.13 mm is utilized, while for viscosities of greater than 200 mPa·s a cone/plate measuring system (Searle system with CP 50-1 measuring cone) is used. The shear rate is adjusted to the polymer viscosity (1 to 99 mPa·s at 100 s⁻¹; 100 to 999 mPa·s at 200 s⁻¹; 1000 to 2999 mPa·s at 120 s⁻¹; 3000 to 4999 mPa·s at 80 s⁻¹; 5000 to 9999 mPa·s at 62 s⁻¹; 10 000 to 12 499 mPa·s at 50 s⁻¹; 12 500 to 15 999 mPa·s at 38.5 s⁻¹; 16 000 to 19 999 mPa·s at 33 s⁻¹; 20 000 to 24 999 mPa·s at 25 s⁻¹; 25 000 to 29 999 mPa·s at 20 s⁻¹; 30 000 to 39 999 mPa·s at 17 s⁻¹; 40 000 to 59 999 mPa·s at 10 s⁻¹; 60 000 to 149 999 at 5 s⁻¹;150 000 to 199 999 mPa·s at 3.3 s⁻¹; 200 000 to 299 999 mPa·s at 2.5 s⁻¹; 300 000 to 1 000 000 mPa·s at 1.5 s⁻¹).

In the context of the present invention, the number-average and weight-average molecular weights Mn and Mw are determined as follows:
Method: Size Exclusion Chromatography (SEC) according to DIN 55672-1
Flow rate: 1.00 mL/min
Injection system: Agilent 1200 autosampler (Agilent Technologies)
Injection volume: 100 µL
Eluent: In the case of products containing phenyl groups, tetrahydrofuran >99.5% was used, stabilized with 250 ppm of 2,6-di-tert-butyl-4-methylphenol (BHT); in the case of materials not containing phenyl groups, toluene >99.9%, analytical grade, was used.

All chemicals are available commercially from, for example, Merck KGaA, D-Darmstadt (DE).

Column: Stationary phase: polystyrene-divinylbenzene from Agilent Technologies. Four columns were connected in series, consisting of a precolumn 50 mm long and three separating columns each 300 mm long. All of the columns had an internal diameter of 7.8 mm. The gels used had a particle size of 5 µm. The pore size of the precolumn was 500 Å, with that of the three separating columns being, in sequence, 10 000 Å, 500 Å and 100 Å.

Column temperature: oven temperature 45° C. The concentration was determined using an RI detector (measuring principle: deflection, type: Agilent 1200; cell volume: 8 µL; temperature: 45° C.).

The system was calibrated using polystyrene standards likewise available commercially from Agilent. Concentration: 0.4 g/L (EasiCal, ready-made polystyrene calibration agent; injection volume: 100 µL). As an internal standard for toluene as eluent, tetrahydrofuran was used as a marker substance, and as an internal standard for tetrahydrofuran as eluent, toluene was used as a marker substance. Fitting of calibration curves: 3^{rd} order polynomial Fit PSS.

Sample preparation: about 15-50 mg of the sample to be measured were dissolved in the respective eluent (c = about 3-10 mg/mL). The amount of sample was made such as to allow a distinct RI signal to be obtained. All of the samples could be dissolved completely in the eluent.

Evaluation: the molar weights determined were in each case rounded to whole hundreds.

The marginal-zone soiling of porous substrates was measured according to ASTM (American Society for Testing and Materials) C 1248. The test specimens, composed of sealant and sandstone, were vulcanized at 23° C. for 21 days and 50% relative humidity and then compressed by 25%, after which they were stored for a total of 28 days
1) at 23° C. and 50% relative humidity,
2) at 70° C. in a thermal cabinet, and
3) in a UV test chamber as described in ASTM C 1248.

Following this, the marginal-zone soiling is assessed visually. If there is no visible marginal-zone soiling, the result is 0 mm. If marginal-zone soiling is determined, then a result is reported of the maximum width of the zone exhibiting the greatest soiling, in mm, rounded to a whole number.

In the examples below, all of the mixtures were produced in a Labmax planetary mixer.

### EXAMPLE 1

### Preparation of Siloxane A1

A mixture of 660 g of an α,ω-dihydroxypolydimethylsiloxane having a viscosity of 80 000 mPas and 220 g of an α,ω-dihydroxypolydimethylsiloxane having a viscosity of 20 000 mPas were stirred with 30.44 g of a solution of 0.04 g of 1,5,7-triazabicyclo[4.4.0]dec-5-ene in 30.4 g of (2,3,5,6-tetrahydro-1,4-oxazin-4-yl)methyltriethoxysilane for 5 minutes at 200 revolutions/min. After a reaction time of 5 minutes, a mixture is obtained of 98.0 wt% of α,ω-bis((2,3,5,6-tetrahydro-1,4-oxazin-4-yl)methyldiethoxysilyl)polydimethylsiloxane, 1.9 wt% of (2,3,5,6-tetrahydro-1,4-oxazin-4-yl)methyltriethoxysilane and 0.1 wt% of ethanol, having a viscosity of 52 000 mPas.

### Production of the Mixture M1

455 g of the reaction mixture obtained in the preparation of the siloxane A1 were admixed with 10.6 g of tetraethoxysilane hydrolysate oligomer having an SiO₂ content of 40% on total hydrolysis and condensation, available from Wacker Chemie AG, Munich, (DE), under the designation “SILIKAT TES 40”, 12.6 g of an equilibration product of 6.3 g of methyltriethoxysilane hydrolysate oligomer having on average 10 Si atoms per molecule, and 6.3 g of 3-aminopropyltriethoxysilane, and the mixture was stirred for a further 5 minutes at 200 revolutions/min. Then 44 g of a hydrophilic pyrogenic silica having a surface area of 150 m²/g, available from Wacker Chemie AG under the designation HDK® V15A, were added and the mixture was stirred initially at 200 revolutions/min for a further 5 minutes until all of the pyrogenic silica was wetted. Stirring then continued for 10 minutes at 600 revolutions/min under a reduced pressure of 200 mbar. Lastly 1.58 g of a solution of 0.27 g of dioctyltin oxide in 1.31 g of an equilibration product composed of 0.655 g of methyltriethoxysilane hydrolysate oligomer having an average 10 Si atoms per molecule and 0.655 g of 3-aminopropyltriethoxysilane and 3 g of a 33 wt% solution of octyl phosphonic acid in phenyltrimethoxysilane were added and the mixture was stirred for a further 5 min under reduced pressure (200 mbar).

The mixture is subsequently dispensed into standard commercial cartridges and stored in the absence of moisture. 24 h after the production of the mixtures, plaques 2 mm thick were drawn from these mixtures and from these plaques, after curing for seven days at 23° C. and 50% relative humidity, type 2 dumbbell specimens according to ISO 37, 6^{th} edition 2017-11, were produced.

The results are given in table 1.

### EXAMPLE 2

### Preparation of an Oligomer Mixture B2-2

240 g (3.25 mol) of an α,ω-bis(trimethylsiloxy)polydimethylsiloxane having a viscosity of 1000 mPas, 234 g (1.0 mol) of trimethoxy(2,4,4-trimethylpentyl)silane (= iOctSi(OMe)₃), available from Wacker Chemie AG under the designation SILRES® BS 1316, and 0.80 g of a solution of sodium ethoxide (21%) in ethanol are mixed and the mixture is heated at 110° C. for four hours. After the solution has cooled, the mixture is neutralized by addition of 1.60 g of a solution of dimethyldichlorosilane (10%) in n-heptane. This mixture was devolatilized at a reduced pressure of 50 mbar at 120° C. on a rotary evaporator. The composition of the mixture was determined by means of 29-Si NMR spectroscopy. The mixture contained 1.4 wt% of iOctSi(OMe)₃, 0.4 wt% of Me₂Si(OMe)₂ and 98.2 wt% of an oligomer mixture with an average composition of [iOctSi(OMe)₂O_{½}]₀.₀₈[iOctSi(OMe)O_{2/2}]₀.₁₅[iOctSiO_{3/2}]₀.₀₅ [Me₂SiO_{2/2}]_{0.43}[Me₂Si(OMe)O_{½}]_{0.29}. The molecular weights as determined by gel permeation chromatography were 929 g/mol (Mw) and 635 (Mn). The polydispersity (Mw/Mn) was 1.46.

### Production of the Mixture M2

The production of the mixture M1 as described in example 1 was repeated. Additionally 36 g of the above-described oligomer mixture B2-2 were admixed.

The mixture M2 is subsequently dispensed into standard commercial cartridges and stored in the absence of moisture. 24 h after the production of the mixtures, plaques 2 mm thick were drawn from these mixtures and from these plaques, after curing for seven days at 23° C. and 50% relative humidity, type 2 dumbbell specimens according to ISO 37, 6^{th} edition 2017-11, were produced.

The results are given in table 1.

### EXAMPLE 3

### Preparation of Siloxane A3

A mixture of 660 g of an α,ω-dihydroxypolydimethylsiloxane having a viscosity of 80 000 mPas and 220 g of an α,ω-dihydroxypolydimethylsiloxane having a viscosity of 20 000 mPas were stirred with 30.44 g of a solution of 0.04 g of 1,5,7-triazabicyclo[4.4.0]dec-5-ene in 30.4 g of phenyltrimethyoxysilane for 30 minutes at 200 revolutions/min. After a reaction time of 30 minutes, a mixture is obtained of 98.0 wt% of α,ω-bis((phenyldimethoxysilyl)polydimethylsiloxane, 1.9 wt% of phenyltrimethoxysilane and 0.1 wt% of methanol, having a viscosity of 51 000 mPas.

### Production of the Mixture M3

The procedure for producing the mixture M1 as described in example 1 was repeated, with the modification that the siloxane used was siloxane A3 rather than A1.

The mixture M3 is subsequently dispensed into standard commercial cartridges and stored in the absence of moisture. 24 h after the production of the mixtures, plaques 2 mm thick were drawn from these mixtures and from these plaques, after curing for seven days at 23° C. and 50% relative humidity, type 2 dumbbell specimens according to ISO 37, 6^{th} edition 2017-11, were produced.

The results are given in table 1.

### EXAMPLE 4

### Production of the Mixture M4

The procedure for producing the mixture M1 as described in example 1 was repeated, with the modification that the siloxane used was siloxane A3 rather than A1. Additionally 36 g of the above-described oligomer mixture B2-2 were admixed.

The mixture M4 is subsequently dispensed into standard commercial cartridges and stored in the absence of moisture. 24 h after the production of the mixtures, plaques 2 mm thick were drawn from these mixtures and from these plaques, after curing for seven days at 23° C. and 50% relative humidity, type 2 dumbbell specimens according to ISO 37, 6^{th} edition 2017-11, were produced.

The results are given in table 1.

### EXAMPLE 5

### Preparation of Siloxane A5

A mixture of 660 g of an α,ω-dihydroxypolydimethylsiloxane having a viscosity of 80 000 mPas and 220 g of an α,ω-dihydroxypolydimethylsiloxane having a viscosity of 20 000 mPas were stirred with 53.2 g of a solution of 0.1 g of 1,5,7-triazabicyclo[4.4.0]dec-5-ene in 53.1 g of n-hexadecyltrimethyoxysilane for 60 minutes at 200 revolutions/min. After a reaction time of 60 minutes, a mixture is obtained of 95.3 wt% of α,ω-bis(n-hexadecyldimethoxysilyl)polydimethylsiloxane, 4.6 wt% of phenyltrimethoxysilane and 0.1 wt% of methanol, having a viscosity of 50 200 mPas.

### Production of the Mixture M5

The procedure for producing the mixture M1 as described in example 1 was repeated, with the modification that the siloxane used was siloxane A5 rather than A1. Additionally 36 g of the above-described oligomer mixture B2-2 were admixed.

The mixture M5 is subsequently dispensed into standard commercial cartridges and stored in the absence of moisture. 24 h after the production of the mixtures, plaques 2 mm thick were drawn from these mixtures and from these plaques, after curing for seven days at 23° C. and 50% relative humidity, type 2 dumbbell specimens according to ISO 37, 6^{th} edition 2017-11, were produced.

The results are given in table 1.

### EXAMPLE 6

### Preparation of Siloxane A6

A mixture of 660 g of an α,ω-dihydroxypolydimethylsiloxane having a viscosity of 80 000 mPas and 280 g of an α,ω-trimethylsiloxypolydimethylsiloxane having a viscosity of 10 mPas were stirred with 38.24 81.08 g of a solution of 0.04 g of 1,5,7-triazabicyclo[4.4.0]dec-5-ene in 38.2 g of phenyltrimethyoxysilane for 30 minutes at 200 revolutions/min. After a reaction time of 30 minutes, a mixture is obtained of 98.0 wt% of α,ω-bis(phenyldimethoxysilyl)polydimethylsiloxane, 1.9 wt% of phenyltrimethoxysilane and 0.1 wt% of methanol, having a viscosity of 50 800 mPas.

### Production of the Mixture M6

455 g of the reaction mixture obtained in the preparation of the siloxane A6 were admixed with 11.1 g of an equilibration product of 5.55 g of methyltriethoxysilane hydrolysate oligomer having on average 10 Si atoms per molecule, and 5.55 g of 3-aminopropyltriethoxysilane, and the mixture was stirred for a further 5 minutes at 200 revolutions/min. Then 42.2 g of a hydrophilic pyrogenic silica having a surface area of 150 m²/g, available from Wacker Chemie AG under the designation HDK® V15A, were added and the mixture was stirred initially at 200 revolutions/min for a further 5 minutes until all of the pyrogenic silica was wetted. Stirring then continued for 10 minutes at 600 revolutions/min under a reduced pressure of 200 mbar. Lastly 1.78 g of a solution of 0.30 g of dioctyltin oxide in 1.48 g of an equilibration product composed of 0.74 g of methyltriethoxysilane hydrolysate oligomer having an average 10 Si atoms per molecule and 0.74 g of 3-aminopropyltriethoxysilane and 2.2 g of a 33 wt% solution of octyl phosphonic acid in phenyltrimethoxysilane were added and the mixture was stirred for a further 5 min under reduced pressure (200 mbar).

The mixture M6 is subsequently dispensed into standard commercial cartridges and stored in the absence of moisture. 24 h after the production of the mixtures, plaques 2 mm thick were drawn from these mixtures and from these plaques, after curing for seven days at 23° C. and 50% relative humidity, type 2 dumbbell specimens according to ISO 37, 6^{th} edition 2017-11, were produced.

The results are given in table 1.

TABLE 1

| Example | Tensile strength [MPa] | Elongation at break [%] | Stress at 100% elongation [MPa] | Marginal-zone soiling [mm] |
|---|---|---|---|---|
| 1 | 2.1 | 260 | 0.73 | 0 |
| 2 | 2.0 | 390 | 0.55 | 0 |
| 3 | 1.9 | 310 | 0.68 | 0 |
| 4 | 1.7 | 440 | 0.38 | 0 |
| 5 | 1.5 | 680 | 0.39 | 0 |
| 6 | 1.3 | 455 | 0.38 | 0 |

Soiling of the marginal zone was not found for any of the examples.

After the wetting of the test specimens with water, no hydrophobized regions were found in the sandstone.

1-9. (canceled)

10. A composition crosslinkable by condensation reaction and producible using (A) organopolysiloxanes of the formula 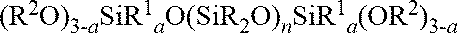
where
R may be identical or different and denotes monovalent, optionally substituted hydrocarbon radicals,
R¹ may be identical or different and denotes monovalent, optionally substituted hydrocarbon radicals,
R² may be identical or different and denotes monovalent, optionally substituted hydrocarbon radicals,
a may be identical or different and is 0 or 1, and
n is an integer from 380 to 2000,
with the proviso that the viscosity at 25° C. is greater than or equal to 6000 mPas and R¹ is phenyl radical, radical —CH₂—NR^{6′}R^{5′} or the radical CH₂NR^{11′}, where R^{5′} denotes hydrocarbon radicals having 1 to 12 carbon atoms, R^{6′} denotes hydrogen atom or radical R^{5′}, and R^{11′} denotes divalent hydrocarbon radicals which may be interrupted by heteroatoms,
(B1) silanes of the formula 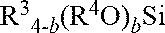
in which
R³ may be identical or different and denotes a monovalent, SiC-bonded, optionally substituted hydrocarbon radical,
R⁴ may be identical or different and denotes a monovalent, optionally substituted hydrocarbon radical, and
b is 2, 3 or 4,
with the proviso that the molecular weight of the silanes of the formula (II) is greater than 195 g/mol,
and optionally
(B2) silicon compounds consisting of units of the formula 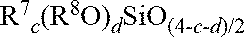
in which
R⁷ may be identical or different and denotes a monovalent, SiC-bonded, optionally substituted hydrocarbon radical,
R⁸ may be identical or different and denotes a monovalent, optionally substituted hydrocarbon radical,
c is 0, 1 or 2, and
d is 0, 1, 2 or 3,
with the proviso that in formula (III) the sum c+d is ≤3, there are at least 2 groups (R⁸O) present in the silicon compounds, and the viscosity at 25° C. is less than 2000 mPas,
with the proviso that the composition contains organosilicon compounds having a molecular weight of less than or equal to 195 g/mol maximally in amounts of less than 0.5 wt%, based on organopolysiloxane (A).

11. The composition as claimed in claim 10, characterized in that the radicals R³ are linear, branched or cyclic hydrocarbon radicals having 1 to 16 carbon atoms or are monovalent hydrocarbon radicals that have 1 to 12 carbon atoms and are substituted by amino groups on the carbon atom bonded to the silicon atom.

12. The composition as claimed in claim 10, characterized in that component (B1) comprises tetraethoxysilane, 2,2,4-trimethylpentyltrimethoxysilane, (2,3,5,6-tetrahydro-1,4-oxazin-4-yl)methyltriethoxysilane, phenyltrimethoxysilane or n-hexadecyltrimethoxysilane.

13. The composition as claimed in claim 10, wherein the composition comprises component (B1) in amounts of 0.5 to 7 parts by weight, based on 100 parts by weight of component (A).

14. The composition as claimed in claim 10, wherein the composition comprises organosilicon compounds having a molecular weight of less than or equal to 195 g/mol maximally in amounts of less than 0.1 wt%, based on organopolysiloxane (A).

15. The composition as claimed in claim 10, wherein the composition is producible using
(A) organopolysiloxanes of the formula (I),
(B1) silanes of the formula (II),
(B2) silicon compounds consisting of units of the formula (III),
optionally (C) adhesion promoters,
optionally (D) curing accelerators,
optionally (E) plasticizers,
optionally (F) fillers, and
optionally (G) additives.

16. The composition as claimed in claim 10, wherein the composition contains no plasticizers (E).

17. A method for producing the composition as claimed in claim 10 by mixing of the individual constituents.

18. A shaped article produced by crosslinking the composition as claimed in claim 10.
